(19) United States
(12) Patent Application Publication
(10) Pub. No.: US 2023/0294533 A1
(43) Pub. Date: Sep. 21, 2023

(54) SYSTEMS AND METHODS FOR PORTABLE ELECTRIC VEHICLE CHARGING

(71) Applicant: Rev Charger Systems Inc., Columbus, OH (US)

(72) Inventors: James Burchfield, Columbus, OH (US); Josiah Lindquist, Columbus, OH (US); Cameron Scheidler, Columbus, OH (US)

(21) Appl. No.: 18/122,493

(22) Filed: Mar. 16, 2023

Related U.S. Application Data
(60) Provisional application No. 63/320,364, filed on Mar. 16, 2022.

(51) Int. Cl. B60L 53/30; H02J 3/32; H02J 3/38; H02J 7/02; B60L 53/62; B60L 53/52; B60L 53/53; B60L 53/16; B60L 53/18; B60L 53/64

(52) U.S. Cl. CPC B60L 53/30; H02J 3/322; H02J 3/381; H02J 7/02; B60L 53/62; B60L 53/52; B60L 53/53; B60L 53/16; B60L 53/18; B60L 53/64; H02J 2207/20; H02J 2310/48

(57) ABSTRACT

A system for charging electric vehicles, comprising an AC electrical power grid supply; and a portable charging station housing containing charging components therein, the charging components comprising an energy storage solution; a plurality of power units coupled to the energy storage solution, wherein the power units convert power to DC power; at least one charging kiosk that receives the DC power from the power units; and a plurality of charging points for the electric vehicles.

### CROSS-REFERENCE TO RELATED APPLICATIONS

This patent application claims the benefit of U.S. Provisional Patent Application Ser. No. 63/320,364 filed on Mar. 16, 2022 and entitled “Portable Charging Station,” the disclosure of which is incorporated by reference herein in its entirety and made part of the present U.S. utility patent application for all purposes.

### BACKGROUND

The disclosed technology relates in general to Electric Vehicle (“EV”) charging systems, devices, and methods, and more specifically to a system and method for charging EVs and that is modular and can be easily deployed to support EV adoption.

Current EV charging systems and technologies are helping pave the way for faster and more efficient charging. Generally, these systems may include specifically designed energy storage, power generation, or charging points/stations that work to more efficiently charge EVs. However, such systems and technologies often require costly, pre-installed onsite infrastructure before use, which greatly limits EV adoption in areas. These systems and stations are often placed where utility support exists, rather than in easily-accessible locations for drivers and EV users. The requirement of power grid upgrades and the aging of distribution transformers are also a concern with current EV charging systems and technologies.

Furthermore, when businesses pay to install traditional charging stations, those stations cannot move with the business if and when the business leaves their physical location. Accordingly, there is an ongoing need for a system and method that allows for fast EV charging while supporting the electrification of transport refrigeration units (“TRUs”) in a manner that requires minimal onsite construction infrastructure, while simultaneously preventing overtaxing of the electrical grid to increase grid reliability.

### SUMMARY

The following provides a summary of certain example embodiments and implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”, and “including” should be interpreted to mean “including without limitation.”

A first example embodiment of the disclosed technology provides a system for charging electric vehicles, comprising an AC electrical power grid supply; and a portable charging station housing containing charging components therein. The charging components comprising an energy storage solution; a plurality of power units coupled to the energy storage solution, wherein the power units convert the power to DC power; at least one charging kiosk that receives the DC power from the power units; and a plurality of charging points for the electric vehicles.

In one or more embodiments, the charging components further comprise a metering point that monitors power provided to the system. In one or more embodiments, the charging components further comprise a second metering point for monitoring the power provided to the energy storage solution and the docking stations; and a common coupling point that maintains charging of the electrical vehicles if the power grid fails. In one or more embodiments, the charging components further comprise an onsite power generator coupled to the energy storage solution, wherein the onsite power generator provides power in the form of solar, turbine systems, biofuel, geothermal, hydrofuel, or renewable energy. The charging components are pre-mounted and pre-wired within the portable charging station housing to allow for quick transport and install of the charging station housing. In one or more embodiments, the energy storage solution includes a battery comprising energy cells or power cells that supply power to charge the electric vehicles, wherein the energy storage solution further includes a battery management solution to optimize power load efficiency, wherein when the battery is not charging the electric vehicles, the battery refuels its energy reserve without overtaxing the power grid. In one or more embodiments, the energy storage solution is capable of pulling and storing energy from the power grid during off-peak hours when costs are low, and is capable of providing the energy back to the power grid during peak hours when the costs are high. The at least one charging kiosk comprises at least two combined charging connector cables and charger plugs for dispensing the DC power to the electric vehicles at the plurality of charging points. In one or more embodiments, the charging components further comprise a waiting area for a user during charging of their electric vehicle; and a restroom for the user, supply closet, or storage room. In one or more embodiments, the portable charging station housing is fabricated from International Organization for Standardization (“ISO”) shipping container, wherein the ISO shipping containers provide stability and protection to the charging station housing and the charging components therein.

In one or more embodiments, the disclosure provides an electrical vehicle charging system used with an AC electrical power grid supply, comprising a portable charging station housing with pre-mounted and pre-wired charging components housed within the charging station housing. The components a plurality of transport refrigeration unit docking stations with AC power connectors; an energy storage solution comprising a battery that supplies power to charge the electric vehicle, wherein the battery refuels its energy reserve when not charging the electric vehicle; a plurality of power units coupled to the energy storage solution, wherein the power units convert the power to DC power; and at least one charging kiosk that receives the DC power from the power units, wherein the at least one charging kiosk comprises at least two combined charging connector cables and charger plugs for dispensing the DC power to the electric vehicle at a plurality of charging points.

In one or more embodiments, the charging components further comprise a metering point that monitors power provided to the system. In one or more embodiments, the charging components further comprise a second metering point for monitoring the power provided to the energy storage solution and the docking stations; and a common coupling point that maintains charging of the electrical vehicle if the power grid fails. In one or more embodiments, the charging components further comprise an onsite power generator coupled to the energy storage solution, wherein the onsite power generator can provide power in the form of solar, turbine systems, biofuel, geothermal, hydrofuel, or renewable energy. The energy storage solution is capable of pulling and storing energy from the power grid during off-peak hours when costs are low, and is capable of providing the energy back to the power grid during peak hours when the costs are high. In one or more embodiments, the charging components further comprise a waiting area for a user during charging of their electric vehicle; and a restroom for the user, supply closet, or storage room. In one or more embodiments, the portable charging station housing is fabricated from International Organization for Standardization (“ISO”) shipping container, wherein the ISO shipping containers provide stability and protection to the charging station housing and the charging components therein.

In one or more embodiments, the disclosure provides a method for supplying a charge to an electric vehicle, comprising installing an AC electrical power grid supply at a vehicle charging site; positioning and wiring charging components within a portable charging station housing. The charging components include a plurality of transport refrigeration unit docking stations with AC power connectors; an energy storage solution comprising a battery that supplies power to charge the electric vehicle, wherein the battery refuels its energy reserve when not charging the electric vehicle; a plurality of power units coupled to the energy storage solution, wherein the power units convert the power to DC power; and at least one charging kiosk that receives the DC power from the power units, wherein the at least one charging kiosk comprises at least two combined charging connector cables and charger plugs; transporting the portable charging station housing to the vehicle charging site; connecting the electrical power grid supply to the portable charging station housing; and using the charging connector cables and charger plugs on the at least one kiosk to dispense the DC power to the electric vehicle at a plurality of charging points.

In one or more embodiments, the charging components further comprise an onsite power generator coupled to the energy storage solution; a metering point that monitors the power provided to the charging station; a second metering point for monitoring the power provided to the energy storage solution and the docking stations; and a common coupling point that maintains charging of the electrical vehicle if failure of the power grid In one or more embodiments, the method may further comprise fabricating the portable charging station housing from International Organization for Standardization (“ISO”) shipping containers, wherein the ISO shipping containers provide stability and protection to the charging station housing and the charging components therein.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the summary, drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and, together with the general description given above and detailed description given below, serve to explain the principles of the disclosed subject matter, and wherein:

FIG. 1 is a block diagram illustrating an example embodiment of the disclosed systems and methods for charging EVs;

FIG. 2 depicts a front perspective view of a portable charging station of the systems and methods of FIG. 1;

FIG. 3A is a front view of the portable charging station of FIG. 2;

FIG. 3B is front view of the portable charging station of FIG. 2;

FIG. 4A depicts a front perspective view of another portable charging station that may be used with the systems and methods of FIG. 1;

FIG. 4A is a front view of the portable charging station of FIG. 4A;

FIG. 5A is a front perspective view of another portable charging station that may be used with the systems and methods of FIG. 1;

FIG. 5B is a front view of the portable charging station of FIG. 5A;

FIG. 6 is a front perspective view of yet another portable charging station that may be used with the systems and methods of FIG. 1;

FIG. 7 is a block diagram illustrating another example embodiment of systems and methods for charging EVs that may be performed with the systems and method of FIG. 1;

FIG. 8 depicts a front view of a portable charging station of the systems and methods of FIG. 7; and

FIG. 9 is a front perspective view of the portable charging station of FIG. 8.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

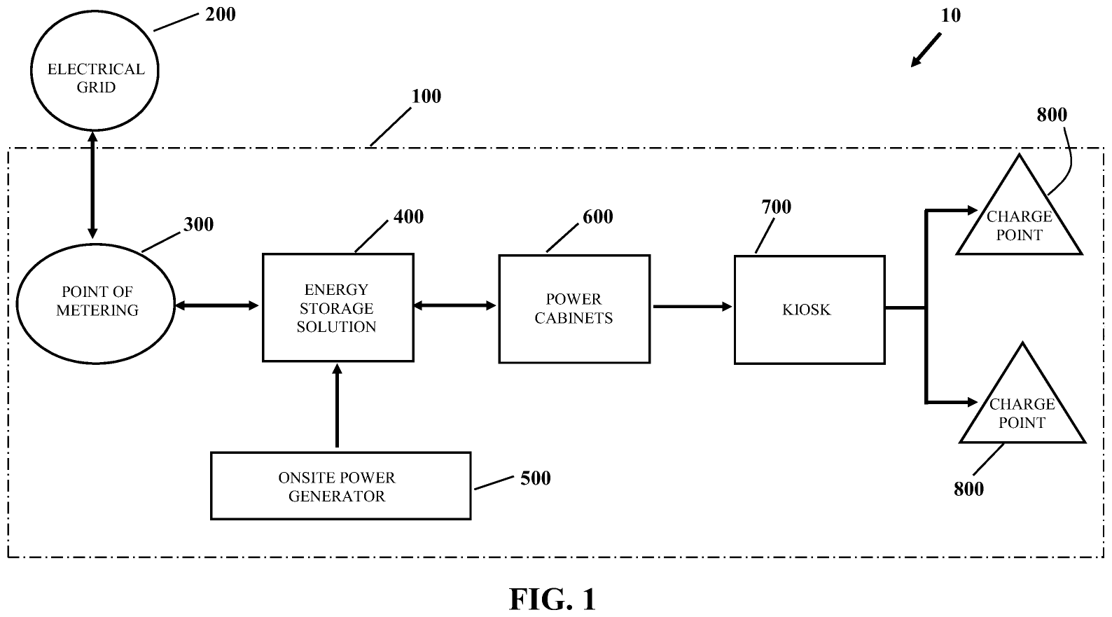

FIG. 1 is a block diagram illustrating an example embodiment of a system 10 for charging electric vehicles (“EV”). Double sided arrows represent the flow of alternating current (“AC”), while single sided arrows represent the flow of direct current (“DC”). The system 10 comprises an AC electrical power grid 200 and a portable charging station 100, wherein the portable charging station 100 includes a point of metering 300, an energy storage solution 400, a power generator 500, a plurality of power cabinets or units 600, at least one charging kiosk 700, and a plurality of charge points 800 all pre-oriented and pre-mounted within the charging station 100. The interconnectivity of the point of metering 300, energy storage solution 400, power generator 500, power cabinets or units 600, charging kiosk 700, and charge points 800 within the charging station 100 are also pre-sleeved and pre-wired.

Installation of the portable charging station 100 on a given site requires only an existing, on site power drop of 3-phase, 480 VAC. The AC electrical power grid 200 supplies 3-phase, 480 VAC distribution as one input to the charging station 100. Specifically, the electrical grid 200 is coupled to the point of metering 300 contained within the portable charging station 100. The point of metering 300 tracks and monitors all of the power provided to support the functioning of EV charging. Such power may include input power from the electrical grid 200 or power generated from the onsite power generator 500, including methods for power generation such as through the use of solar, turbine systems, biofuel, geothermal, hydrofuel, or renewable energy.

Further referring to FIG. 1, the energy storage solution 400 incorporated into the portable charging station 100 of the present disclosure allows for ultra-fast DC charging. The energy storage solution 400 includes a battery comprising of either energy cells or power cells, depending on the best fit of intended site use and the desired speed at which the battery is able to re-charge and discharge its energy. In one or more embodiments, the energy storage solution 400 further comprises a battery management solution to optimize power load efficiency. When the energy storage solution 400 battery is not actively dispensing a charge to an EV, the battery refuels its energy reserve at a rate without overtaxing the grid 200, thus permitting charging even in areas where utility support is limited. In one or more embodiments, the minimum capacity of the energy storage solution 400 is 1 megawatt (“MW”). In one or more embodiments, the maximum capacity of the energy storage solution 400 is 1 gigawatt (“GW”).

In addition to supplying power to the plurality of power cabinets or units 600, the energy storage solution 400 provides energy arbitrage. Electricity providers generally offer time-of-use tariffs to transfer variable energy costs to their customers. The lowest kilowatt-hour (“kWh”) prices are charged during off-peak hours, while the highest kWh prices are charged when the grid 200 is under peak demand. The energy storage solution 400 utilizes a battery management solution to leverage this price difference, pulling and storing energy when prices are low and providing energy back to the grid 200 when prices are high. Further, the energy storage solution 400 may provide peak load shedding. Peak load shedding reduces the individual peak consumption of a site, which is critical when operating in an industrial space with significant demand charges. Demand charges are generally calculated using the highest kilowatt demand measured during a given billing period and are added to the total energy consumption bill. The energy storage solution 400 and its incorporated battery management system are configured to supplement electricity consumption when a given site's demand is rising, thus reducing the total amount of kWh measured by the electricity provider.

In one or more embodiments, the system 10 has the capability to incorporate and integrate onsite power generation. As an additional input to the system 10, onsite power generator 500 provides additional methods of onsite power generation including the use of solar, turbine systems, biofuel, geothermal, hydrofuel, or renewable energy. In one or more embodiments, power generation comes from advanced turbine systems that utilize a variety of fuels including, but not limited to, hydrogen. The system 10 is capable of integrating small scale fusion reactors to provide immediate power to the system 10 in its entirety. In one or more embodiment, substructure and parking pad integrated solar cells can serve as an optional source of power generation. The power generated from the power generator 500 is input into the energy storage solution 400, tracked by the point of metering 300, and supplied to the power cabinets 600. In one or more embodiments, the charging station 100 includes at least two 175 kW power cabinets 600 connected in parallel that convert the power supplied from the energy storage solution 400 from AC power to DC power. In embodiments of the present invention that contain two 175 kW power cabinets 600, the maximum output of the charging station 100 is 350 kW.

The power cabinets 600 transfer the converted DC power to the at least one kiosk 700, wherein the kiosk 700 allows a user to charge their EV at charge points 800. The kiosk 700 can charge all electric vehicles with battery voltages up to 920V DC and 350A DC, compliant with the Combined Charging Systems (“CCS”) standard. In one or more embodiments, a second output from the kiosk 700 is also available in the form of a CHAdeMO charging system with voltage up to 500V DC and current up to 125A DC.

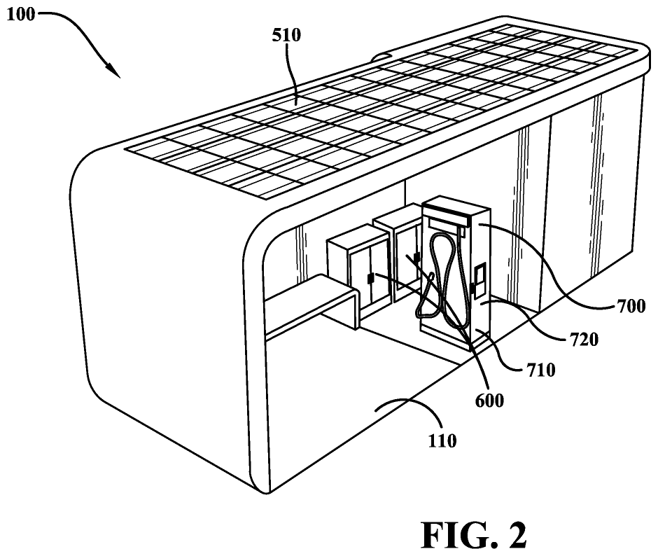

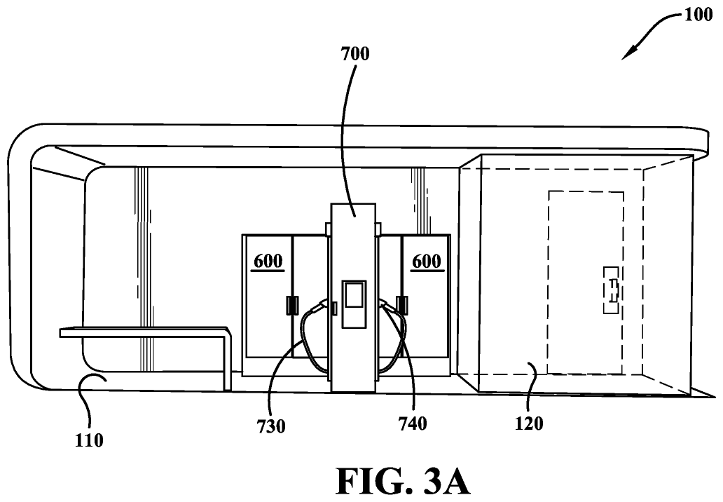

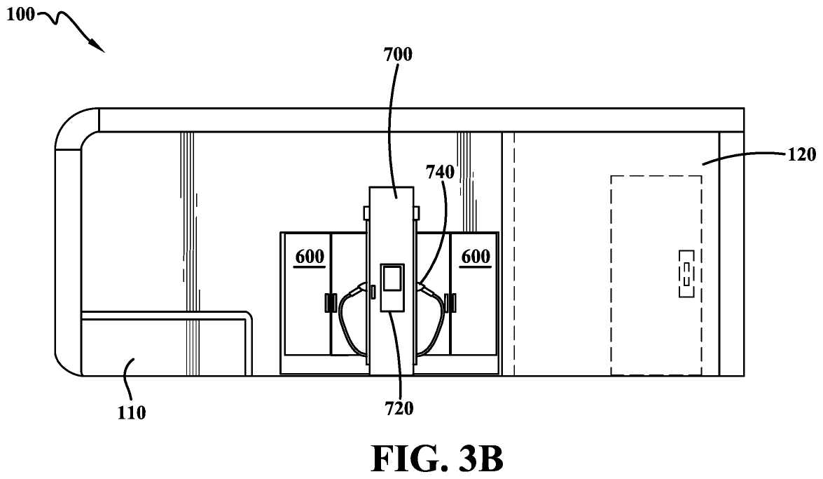

FIGS. 2 and 3A-3B depict differing views of an example embodiment of a portable charging station 100. The portable charging station 100 utilizes portable housing units made from customized ISO shipping containers. The shipping container, and thus the charging station 100, can be any size as long as it meets the ISO standards. In one or more embodiments, the charging station 100 of the present invention is 20×8 feet and in yet other embodiments, the charging station 100 is 10×8 feet. The dimensions and weight of the housing units made from the shipping containers will not be significantly impacted by the modifications needed to turn the housing units into portable charging stations 100, enabling the charging stations 100 to remain an industrial strength entity that allows versatility in intermodal travel. The stability and self-containment of the charging station 100 will also minimize the site development efforts of charging station hosts. The charging station 100 will be more than capable of providing protection for the charging equipment and can include rear paneling to protect the power cabinets 600 and charging equipment from natural elements. Identifying indicia (advertisement, branding, pricing, etc.) may also be included on charging station 100. The charging station 100 may further include a waiting area 110 for a user to occupy during charging of their EV and a walled-off room with door access 120 which may be converted into a user restroom, supply closet, storage facility, or the like.

FIGS. 2 and 3A-3B further depict the plurality of power cabinets 600 and at least one charging kiosk 700. As previously described, the power cabinets 600 convert the supplied power from AC to DC and provide the converted DC power to the kiosk 700. The at least one kiosk 700 includes a pedestal 710 with a user interface monitor 720 to facilitate the beginning and termination of each charging session. In one or more embodiments, the monitor 720 of kiosk 700 displays the battery charging state of each EV. The charging cycle of the EVs battery can finish by itself or can be interrupted by user command.

The kiosk 700 further includes at least two combined charging connector cables 730 and charger plugs 740 for dispensing the DC charge to the user's EV. The charger plugs 740 may correspond to any CCS, Tesla, and CHAdeMO receiver. In embodiments of the present invention that contain two 175 kW power cabinets 600, the maximum output of the charging station 100 is 350 kW. Therefore, if two EVs are actively plugged in at the same kiosk 700, each EV can receive up to 175 kW of charging power. To ensure safety, the power cabinets 600 and the kiosk 700 will step down their power output to match the maximum allowable rate of the EVs battery system.

Once the charger plugs 740 are coupled to the EV and the system performs safety checks, the charge session automatically begins. The charging kiosk 700 has a means of measuring the output energy that can be used for information and monitoring purposes. Kiosk 700 uses remote IP communication via GPRS, Ethernet, WI-FI, or any other internet access method to communicate business management data and technical data. Kiosk 700 prevents reverse energy flow back into the grid and results in top tier specification for conduction of DC fast charging, such as high-power output with an industry best power factor, THD and efficiency. Accordingly, the system 10 and charging station 100 can be beneficial for EV fleets, service stations, and public facing fuel stations and more.

Further referring to FIGS. 2 and 3A-3B, the charging station 100 may further include a solar array system 510. In one embodiment of the present invention, the solar array system 510 is installed into the roof of the charging station 100. In one or more embodiments, the solar array 510 can include at least six 450 W PV panels for a total system output of 2.7 kW per hour of active sunlight. As previously described with reference to FIG. 1, the power output generated from the solar arrays 510 is input into the energy storage solution 400, tracked by the point of metering 300, and supplied to the power cabinets 600. In other embodiments of the present invention, the solar array system 510 may cantilever off the rear of the charging station 100 to facilitate a larger system pending site-specific layouts and operator preferences.

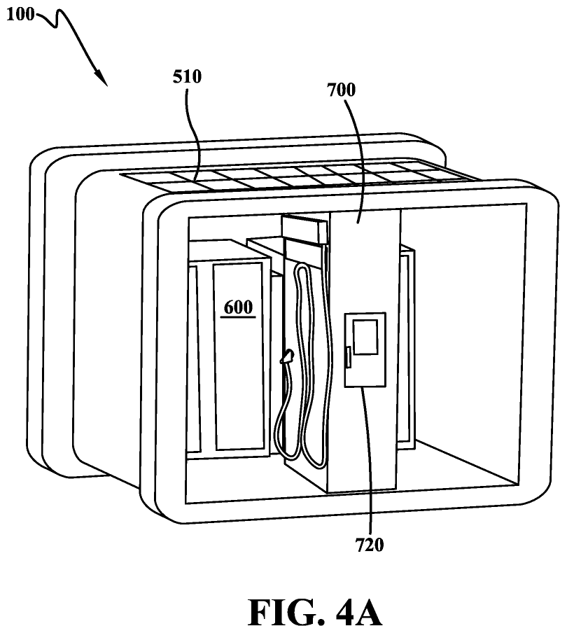

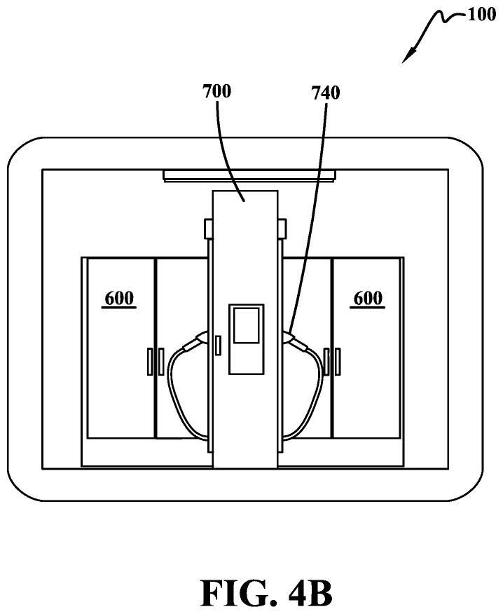

FIGS. 4A-4B depict another embodiment of the portable charging station 100 that can be used within the charging system 10 of the present disclosure. In one or more embodiments, the charging station 100 functions the same as the charging station 100 described and depicted in FIGS. 2 and 3A-3B, the difference being the charging station 100 in this embodiment is 10×8 feet and does not include a waiting area 110 or walled-off area 120. The charging station 100 described and illustrated in FIGS. 4A-4B functions identically to the system 10 described and illustrated in FIG. 1.

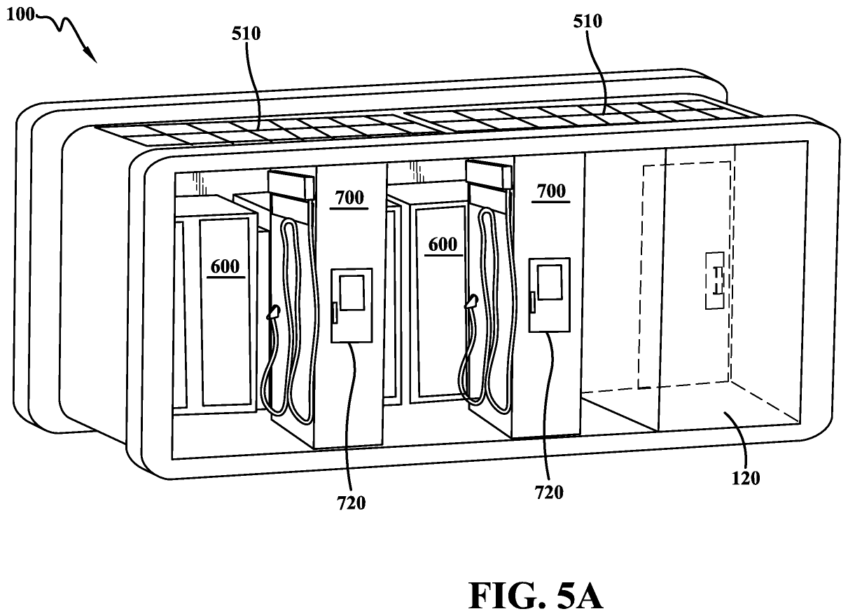

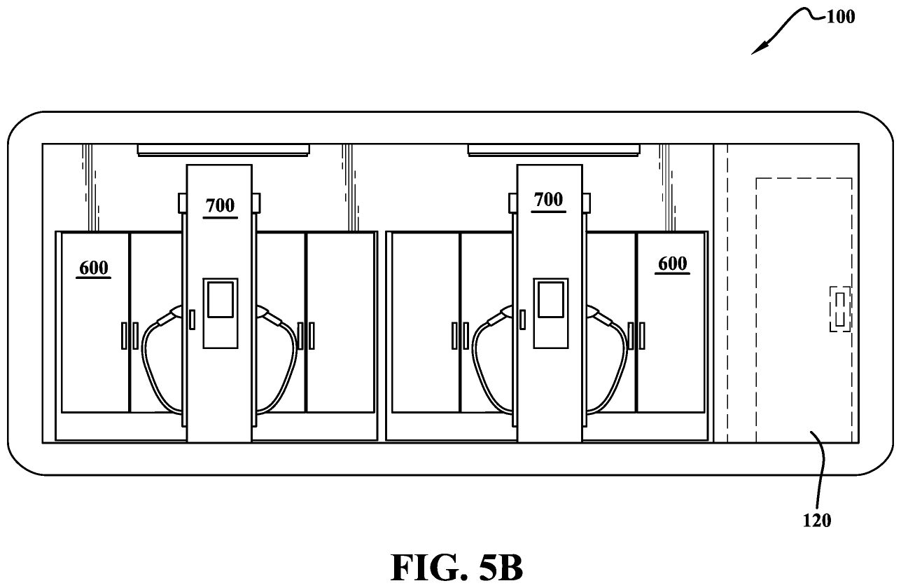

FIGS. 5A-5B depict another embodiment of the portable charging station 100 that can be used within charging system 10 of the present disclosure. In this embodiment, the charging station 100 functions the same as the charging station 100 described and depicted in FIGS. 2 and 3A-3B, the difference being the charging station 100 in this embodiment includes four power cabinets 600 and two kiosks 700, each kiosk 700 having two combined charging connector cables 730 and charger plugs 740 for dispensing the DC charge to the user's EV. In one or more embodiments, the charging station 100 described and illustrated in FIGS. 5A-5B functions similarly to the system 10 described and illustrated in FIG. 1, the difference being the charging station 100 in this embodiment includes four power cabinets 600 that receive power from the energy storage solution 400, wherein the power cabinets 600 supply power to two kiosks 700, such that the system 10 yields four total charge points 800.

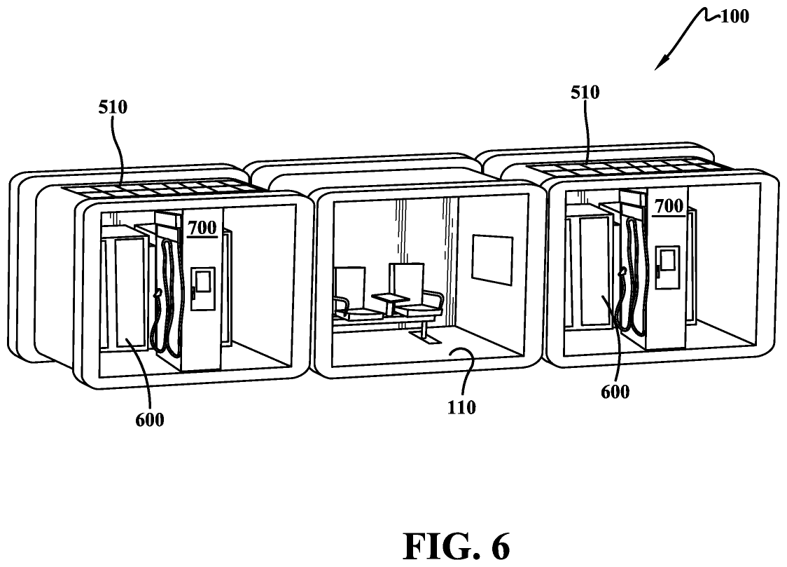

FIG. 6 depicts yet another embodiment of the portable charging station 100 that can be used within the charging system 10 of the present disclosure. In this embodiment, the charging station 100 of FIG. 6 functions in a similar manner as the charging station 100 described and depicted in FIGS. 2 and 3A-3B, the first difference being the charging station 100 in this embodiment is collectively formed from three 10×8 feet portable housing units configured such that charging station 100 includes a 10×8 feet waiting area 110 situated between two 10×8 feet kiosks 700. The charging station 100 described and illustrated in FIG. 6 functions similarly to the system 10 described and illustrated in FIG. 1, the difference being the charging station 100 in FIG. 6 includes four power cabinets 600 that receive power from the energy storage solution 400, wherein the power cabinets 600 supply power to two kiosks 700, such that the system 10 yields four total charge points 800.

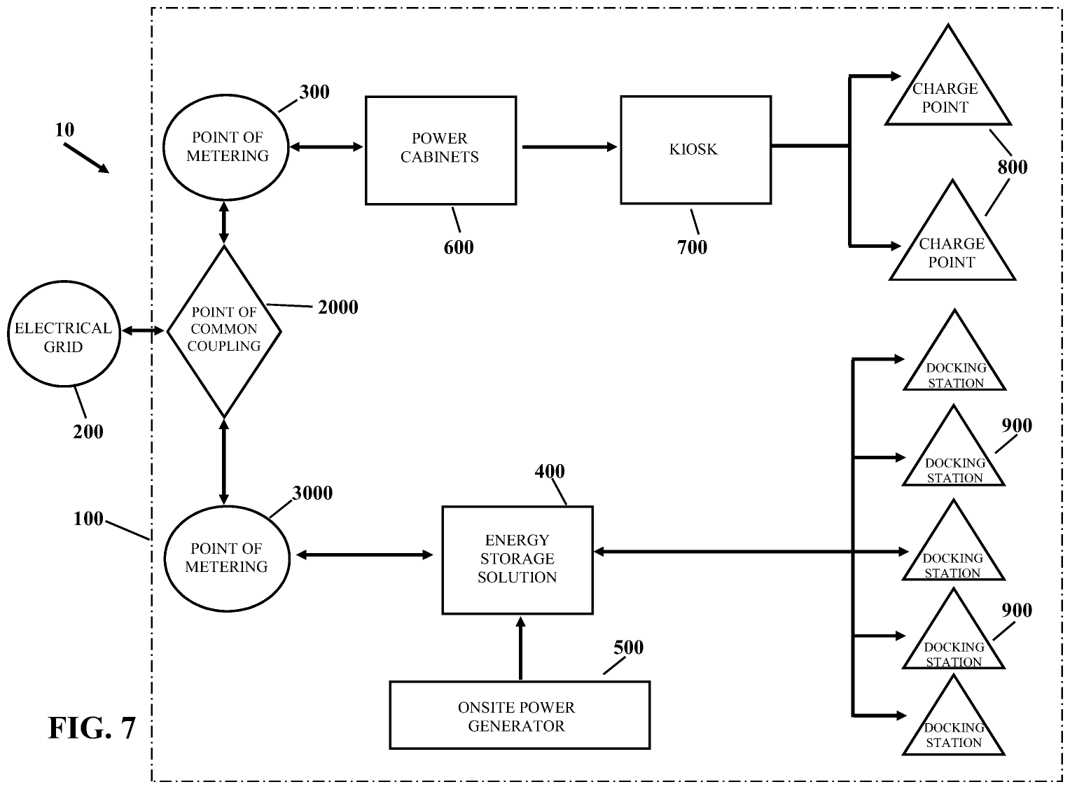

FIG. 7 shows an example embodiment of system 10 that comprises additional features from that described and illustrated in FIG. 1. Double sided arrows represent the flow of AC power, while single sided arrows represent the flow of DC power. In this embodiment, the electric vehicle charging system 10 further includes a point of common coupling (“PCC”) 2000, a second point of metering 3000, and a plurality of transport refrigeration unit (“TRU”) docking stations 900 configured within charging station 100. Electrical power grid 200, point of metering 300, energy storage solution 400, power generator 500, the plurality of power cabinets 600, the at least one charging kiosk 700, and the plurality of charge points 800 all function as previously described and illustrated in the Figures herein. However, system 10 of FIG. 7 includes a plurality of TRU docking stations 900 each with a 480 VAC power connector that provides shore power to an electric or hybrid TRU. TRUs are often an overlooked sector of industrial transportation and have a profound environment impact due to the countless gallons of diesel fuel consumed in transportation each year. The TRU docking stations 900 incorporated in the charging station 100 and system 10 are the spring board for scaling electrification efforts throughout every step of the supply chain.

In one or more embodiments, the TRU docking stations 900 are 1-gang power stations configured in a compact orientation that energize refrigerated trucks and trailers with a safety-interlocked door, a 30A 3P circuit breaker rated 35kAIC @ 480 VAC that provides short circuit and overcurrent protection, and custom length power cords having female connectors with integral sensors that trip the system if the electrical pathway is broken (unplugged, cord cut, drive-off, etc.) before the cords are energized. A red LED located on the docking station 900 indicates an energized female connector. The cords on the TRU docking stations 900 further comprise break-away provisions that enable a technician to re-connect the cords after an electrical pathway break while still plugged in, such as an unintentional user drive-off. In another embodiment, the TRU docking stations 900 can daisy chain to other TRU docking stations 900.

Further, system 10 of FIG. 7 includes a second point of metering 3000 that tracks and monitors all the power provided to support the charging of the energy storage solution 400 and the docking stations 900. Point of metering 3000 allows tracking of the reverse flow of energy back into the grid 200 by way of the onsite power generator 500 and the energy storage solution 400. The PCC 2000 functions as a power disconnect in the event of failure of grid 200. Should electrical grid 200 fail, PCC 200 maintains the functionality of charging station 100 by drawing stored power from energy storage solution 400.

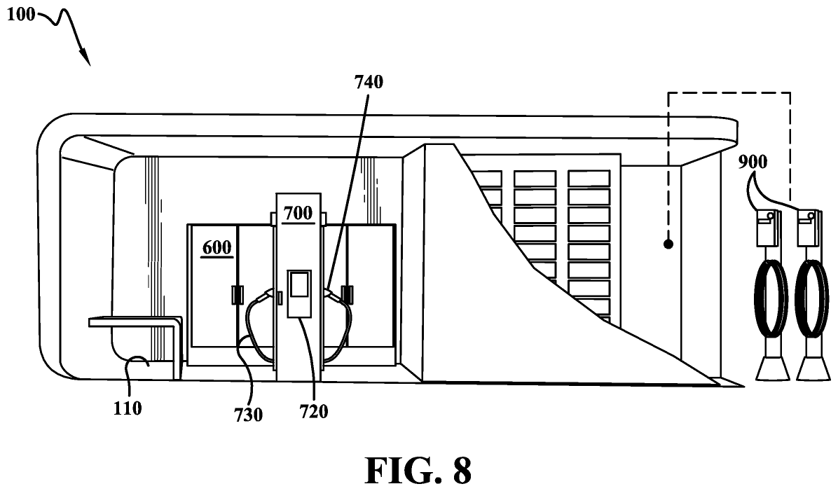

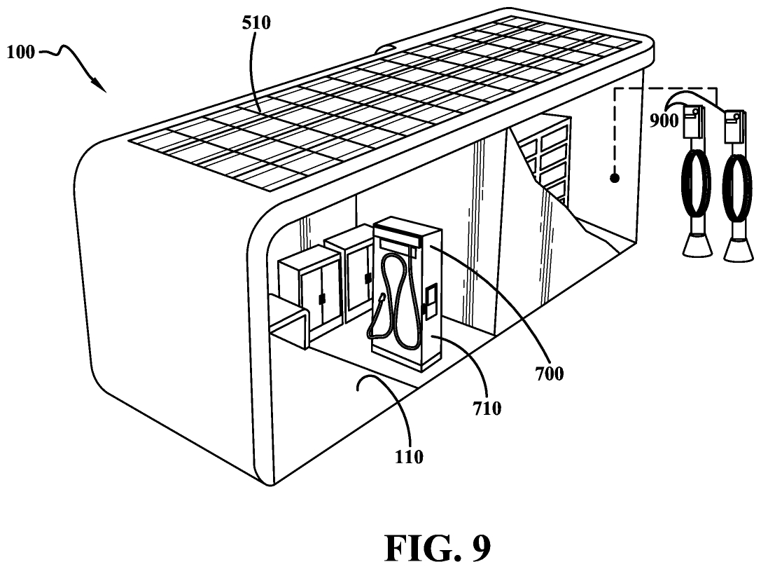

FIGS. 8 and 9 depict differing views of an example embodiment of portable charging station 100 that can be used within the charging system 10 described and illustrated in FIG. 7. The charging station 100 shown in FIGS. 8 and 9 functions in a similar manner as the charging station 100 previously described and illustrated in the Figures herein, the difference being the addition of the PCC 2000, the second point of metering 3000, and the plurality of TRU docking stations 900.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection; a direct connection, or an indirect connection through an intermediate medium. For an ordinary skilled in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A system for charging electric vehicles, comprising:
(a) an AC electrical power grid supply; and
(b) a portable charging station housing containing charging components therein, the charging components comprising:
(i) an energy storage solution;
(ii) a plurality of power units coupled to the energy storage solution, wherein the power units convert power to DC power;
(iii) at least one charging kiosk that receives the DC power from the power units; and
(iv) a plurality of charging points for the electric vehicles.

2. The system of claim 1, wherein the charging components further comprise a metering point that monitors power provided to the system.

3. The system of claim 2, wherein the charging components further comprise a plurality of transport refrigeration unit docking stations with AC power connectors; a second metering point for monitoring the power provided to the energy storage solution and the docking stations; and a common coupling point that maintains charging of the electrical vehicles if the power grid fails.

4. The system of claim 1, wherein the charging components further comprise an onsite power generator coupled to the energy storage solution, wherein the onsite power generator provides power in the form of solar, turbine systems, biofuel, geothermal, hydrofuel, or renewable energy.

5. The system of claim 1, wherein the charging components are pre-mounted and pre-wired within the portable charging station housing to allow for quick transport and install of the charging station housing.

6. The system of claim 1, wherein the energy storage solution includes a battery comprising energy cells or power cells that supply power to charge the electric vehicles, wherein the energy storage solution further includes a battery management solution to optimize power load efficiency, wherein when the battery is not charging the electric vehicles, the battery refuels its energy reserve without overtaxing the power grid.

7. The system of claim 6, wherein the energy storage solution is capable of pulling and storing energy from the power grid during off-peak hours when costs are low, and is capable of providing the energy back to the power grid during peak hours when the costs are high.

8. The system of claim 1, wherein the at least one charging kiosk comprises at least two combined charging connector cables and charger plugs for dispensing the DC power to the electric vehicles at the plurality of charging points.

9. The system of claim 1, wherein the charging components further comprise a waiting area for a user during charging of their electric vehicle; and a restroom for the user, supply closet, or storage room.

10. The system of claim 1, wherein the portable charging station housing is fabricated from International Organization for Standardization (“ISO”) shipping container, wherein the ISO shipping containers provide stability and protection to the charging station housing and the charging components therein.

11. An electrical vehicle charging system used with an AC electrical power grid supply, comprising:
(a) a portable charging station housing with pre-mounted and pre-wired charging components housed within the charging station housing, the components comprising:
(i) a plurality of transport refrigeration unit docking stations with AC power connectors;
(ii) an energy storage solution comprising a battery that supplies power to charge the electric vehicle, wherein the battery refuels its energy reserve when not charging the electric vehicle;
(iii) a plurality of power units coupled to the energy storage solution, wherein the power units convert power to DC power; and
(iv) at least one charging kiosk that receives the DC power from the power units, wherein the at least one charging kiosk comprises at least two combined charging connector cables and charger plugs for dispensing the DC power to the electric vehicle at a plurality of charging points.

12. The system of claim 11, wherein the charging components further comprise a metering point that monitors power provided to the system.

13. The system of claim 12, wherein the charging components further comprise a second metering point for monitoring the power provided to the energy storage solution and the docking stations; and a common coupling point that maintains charging of the electrical vehicle if the power grid fails.

14. The system of claim 11, wherein the charging components further comprise an onsite power generator coupled to the energy storage solution, wherein the onsite power generator can provide power in the form of solar, turbine systems, biofuel, geothermal, hydrofuel, or renewable energy.

15. The system of claim 11, wherein the energy storage solution is capable of pulling and storing energy from the power grid during off-peak hours when costs are low, and is capable of providing the energy back to the power grid during peak hours when the costs are high.

16. The system of claim 11, wherein the charging components further comprise a waiting area for a user during charging of their electric vehicle; and a restroom for the user, supply closet, or storage room.

17. The system of claim 11, wherein the portable charging station housing is fabricated from International Organization for Standardization (“ISO”) shipping container, wherein the ISO shipping containers provide stability and protection to the charging station housing and the charging components therein.

18. A method for supplying a charge to an electric vehicle, comprising:
(a) installing an AC electrical power grid supply at a vehicle charging site;
(b) positioning and wiring charging components within a portable charging station housing, wherein the charging components include:
(i) a plurality of transport refrigeration unit docking stations with AC power connectors;
(ii) an energy storage solution comprising a battery that supplies power to charge the electric vehicle, wherein the battery refuels its energy reserve when not charging the electric vehicle;
(iii) a plurality of power units coupled to the energy storage solution, wherein the power units convert the power to DC power; and
(iv) at least one charging kiosk that receives the DC power from the power units, wherein the at least one charging kiosk comprises at least two combined charging connector cables and charger plugs;
(c) transporting the portable charging station housing to the vehicle charging site;
(d) connecting the electrical power grid supply to the portable charging station housing; and
(e) using the charging connector cables and charger plugs on the at least one kiosk to dispense the DC power to the electric vehicle at a plurality of charging points.

19. The method of claim 18, wherein the charging components further comprise an onsite power generator coupled to the energy storage solution; a metering point that monitors the power provided to the charging station; a second metering point for monitoring the power provided to the energy storage solution and the docking stations; and a common coupling point that maintains charging of the electrical vehicle if failure of the power grid.

20. The method of claim 18, further comprising fabricating the portable charging station housing from International Organization for Standardization (“ISO”) shipping containers, wherein the ISO shipping containers provide stability and protection to the charging station housing and the charging components therein.
